(19) United States
(12) Patent Application Publication
(10) Pub. No.: US 2012/0151467 A1
(43) Pub. Date: Jun. 14, 2012

(54) PROVIDING COM ACCESS TO AN ISOLATED SYSTEM

(75) Inventors: Jose M. Bernabeu-Auban, Sammamish, WA (US); Luis Irun-Briz, Valencia (ES); Stephen E. Dossick, Redmond, WA (US); Frank V. Peschel-Gallee, Redmond, WA (US); Stephan J. Zachwieja, Redmond, WA (US)

(73) Assignee: MICROSOFT CORPORATION, Redmond, WA (US)

(21) Appl. No.: 13/400,915

(22) Filed: Feb. 21, 2012

Related U.S. Application Data
(62) Division of application No. 11/393,453, filed on Mar. 30, 2006.

(51) Int. Cl. G06F 9/445

(52) U.S. Cl. 717/174

(57) ABSTRACT

The database (namespace) for storing component metadata for an application that is to be run in an isolated environment is isolated by an operating system by storing the component metadata in a local set of information associated with the isolated application instead of in a global namespace. The operating system utilizes this local metadata instead of the global database when components are employed. Registration data for components is placed within a manifest, enabling the operating system to determine the relationship between an application and a component or set of components used by the application.

### CROSS-REFERENCE TO RELATED CASES

The present application is a divisional of U.S. application Ser. No. 11/393,453 filed Mar. 30, 2006 entitled “Providing Com Access To An Isolated System” which is incorporated herein in its entirety.

### BACKGROUND

Applications are often made up of many smaller components written using standard programming systems like COM or Enterprise Java Beans. Some of these programming systems allow components to register themselves, discover other components, request that those components be activated and communicate with running instances of the components. A typical operating system provides common facilities and a global namespace to the software that it runs and thus typical software is written assuming that it will have access to global namespaces. A number of drawbacks are associated with this model. For one thing, use of a global namespace makes it possible for one application to maliciously or unintentionally affect another application during concurrent execution. For example, a first application may store its state in a file of a particular name in the global namespace. A second application may store its state in the same file. If the applications execute at the same time, each application's state may be overwritten by the other's. Secondly, machine resources accessed via a global namespace are shared by all the applications running on the machine. Because the application is able to find any resource in the global namespace, the application is potentially able to access and use it.

### SUMMARY

The database (namespace) for storing component metadata for an application that is to be run in an isolated environment is isolated by an operating system by storing the component metadata in a local set of information associated with the isolated application instead of in a global namespace. The operating system enforces the utilization of this local metadata instead of the global database when components are employed. That is, the operating system provides access to only the set of software components represented in the local datastore to the isolated application. Registration data for components is placed within a manifest, enabling the operating system to determine the relationship between an application and a component or set of components used by the application.

The operating system locates the information for a component in the local database instead of in the global database when a component is requested by an application in cases where the component is to execute in the same process as the requesting application.

The operating system locates the information for a component in the local database instead of in the global database when a component is requested by an application in cases where the component is to execute in the different (separate) process as the requesting application. When an application requests a component to be started in a process other than that in which the application is executing, the functionality of a global service in charge of starting a component in its own process, is performed by a support library of the applications utilizing the componentized software system. When the main application activates a component to be run in its own process, the code from that support library loaded in the application is the entity that actually starts the process which executes the activated component. The support library code emulates the behavior of the “standard” global activation service, interacting with the newly created process in a way indistinguishable to it from the global activation service. The code of the component does not require modification in order to work. The amount of sharing of the component is thus governed or controlled by the application starting the component. Only other processes started by that application could get to share a component thus started. Other (unrelated) processes are unable to force sharing of running instances of the component, thus fulfilling the isolation goals described above.

Existing componentized software is re-used without modification in an isolated execution environment. An isolated execution environment prevents one executing application from maliciously or unintentionally affecting another executing application. The operating system isolates executing applications by controlling what resources are available to an executing software entity by creating local namespaces (subsets of the global namespace) which are the only namespaces visible to the executing application.

Access to a global namespace for class information is replaced with access to a set of local files that contain information required to instantiate the componentized process. During instantiation or activation of a new component, if the new component is to run in its own execution environment, the new execution environment is constructed as a child process of the activating process by a local process-creating module, enabling the creation of a controlled (isolated) environment for the new component. Communication between creating and created communication is established by establishing an endpoint from the creating process to the created process and by establishing an endpoint from the created process to the creating process. Endpoints are not shared with other side-by-side applications, enforcing isolation.

### BRIEF DESCRIPTION OF THE DRAWINGS

In the drawings:

FIG. 1 is a block diagram illustrating an exemplary computing environment in which aspects of the invention may be implemented;

FIG. 2 is a block diagram of a system for providing access to components to an isolated application in accordance with some embodiments of the invention; and

FIG. 3 is a flow diagram of a method for providing access to components to an isolated application in accordance with some embodiments of the invention.

### DETAILED DESCRIPTION

### Overview

Running applications in isolation has a number of advantages such as preventing one executing application from unintentionally or maliciously affecting another executing application, preventing common software components from being accidentally overwritten by older or incompatible versions and so on. One way to isolate an application is by controlling what resources are available to a running software entity by creating a local namespace subset that is the only namespace accessible by the software entity.

COM (Component Object Model) is, basically, a programming model and support libraries for creating and using software components. COM is often used in the software development world as an umbrella term that encompasses the OLE, ActiveX, COM+ and DCOM technologies. Those technologies extend the programming model of COM, including aspects of component discovery, and component activation which make COM as it is known today violate the isolation principles described above. Typically componentization systems such as COM, and Enterprise Java Beans rely on a global database in which the components can store information about known components. When a component is introduced to the system (installed) the system takes note of various pieces of information regarding the component. Subsequently, the system can make use of this metadata when (an) application(s) requests information regarding what components exist on the system, which of these components have a specified name and/or which of these components matches a particular interface, which files on the local machine make up the component and so on. In COM, the WINDOWS Registry is used as the global database for this component metadata.

If an application is to be run in an isolated environment, however, the operating system must have a clear understanding of the components the application depends upon, and on how those components must be activated. When such information is maintained as today, in a global database (the Registry for COM, or the File System for Java Beans), accessed by an application to determine which component to activate and how it can be activated, the operating system cannot guarantee that the components the application expects are the ones it will get, activated under the assumptions it expects.

To support componentization in COM and other componentized software systems without changing the program code of existing applications, metadata that in existing system would be stored in the global namespace (like the Registry, for instance) is stored as a local set of information associated with an isolated application. The operating system in accordance with embodiments of the invention utilizes this local metadata instead of the global database when components are employed. In some embodiments of the invention, the local metadata is referred to as a manifest for the component. Registration data which is specific for COM is placed within this manifest, enabling the operating system to determine the relationship between an application and a component or set of components used by the application.

Componentized software systems may currently enable a user or application to specify whether the component code should execute in the same process as the main application (called “in-proc” for COM) or in a separate process from the main application (called out-of-proc for COM). For example, currently, in the class discovery phase of the activation of an in-proc COM process, when an instance of an object of a certain class is required, the class information needed to create the instance is retrieved from the Registry (a global namespace) using a class identifier or CLSID. In class activation or instantiation, the class information retrieved for the CLSID is used by the OLE32.DLL library to create the instance. In-proc COM activation is currently resolved by a Registry (global database) lookup which relates a CLSID to a DLL file. The indicated DLL is loaded and the object is instantiated. In accordance with some embodiments of the invention, the metadata that would have been stored in the global database (i.e., in the Registry for COM) is stored in a local database associated with the isolated main application. The operating system locates the information for the component in the local database instead of in the global database. In the COM example, a local file that establishes the correspondence between CLSID and DLL file is maintained so that the appropriate DLL can be loaded.

Many current componentized systems support the execution of components in a separate process (that is, separate from the main application). This provides a limited amount of execution safety in that coding errors in the component which lead to a crash do not usually cause errors in the main application. In COM, this is called out-of-proc activation. The part of COM which performs out-of-proc activation in WINDOWS is called DCOM. DCOM also is responsible for finding already-running instances of a particular component, to avoid creating different instances of processes running the same component, and serving different applications. Thus in current COM, the same process running a particular component can be shared by different applications which use that component. To achieve this “sharing” effect, the operating system includes a global service called the SCM (service control manager) which is in charge of starting a component (or components, as the case may be) in their own process, when requested, and keeping track of those processes which are executing components which were registered to be run in their own process. Thus an SCM is a logical component responsible for starting a new component in its own process or connecting an application to a running instance of a component running in its own process. (In COM terminology, an SCM starts a new out-of-proc COM component or connects an application to a running instance of an out-of-proc COM component.)

In current COM, the calling application passes just the name or type of the component that it would like to have started to the SCM, which uses the global database (the Registry) to locate the correct component to start and creates a process in which the component can run. The SCM passes the application a communications endpoint which enables the application and the process running the component to communicate. When the SCM is contacted by the application to get the component, the SCM may determine that the component is already running. If so, the SCM does not start a new process for the component. Instead, the SCM passes a communication endpoint to the already existing running process to the application. This mechanism enables sharing of the same process running a component among more than one application. This type of sharing, which is not controlled by the application, violates the principles of isolation described above.

In accordance with embodiments of the invention, the functionality of the global service in charge of starting a component (or components, as the case may be) in their own process, is transferred to the support library of the applications utilizing the componentized software system. When the main application activates a component to be run in its own process, the code from that support library loaded in the application is the one actually starting the process which executes the activating component. The support library code, emulates the behavior of the “standard” global COM activation service, interacting with the newly created process in a way indistinguishable to it from the global COM activation. The code of the component would not require modification in order to work. This approach enables the amount of sharing of the component to be governed or controlled by the application starting the component. Only other processes started by that application would be affected. Other (unrelated) processes are unable to force sharing of running instances of the component, thus fulfilling the isolation goals described above.

For example, (using COM terminology), the functionality of the global SCM may be transferred to the OLE32.DLL library. When a COM application activates an out-of-proc component, a local SCM is created within the application process. The local SCM is able to activate the component-running process and maintains communication between application and component processes. The code of the COM components does not require modification to work with the approach described. The COM application that requests the out-of-proc component controls the amount of sharing of the running instance of the out-of-proc component allowed. Only processes started by the COM application are able to share the out-of-proc component.

### Exemplary Computing Environment

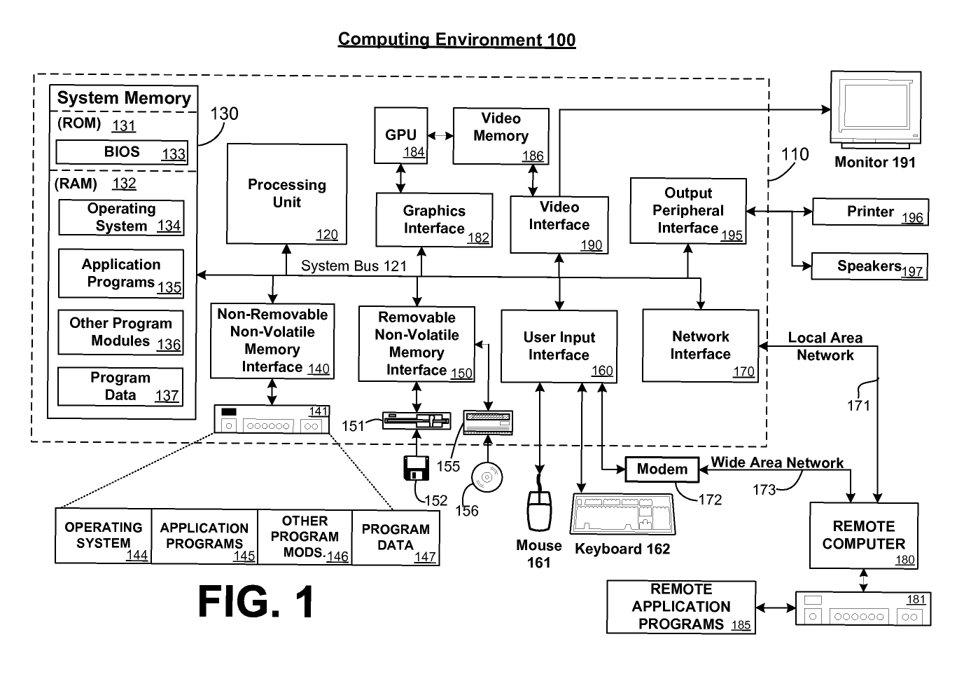

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

### Providing COM Access to an Isolated Application System

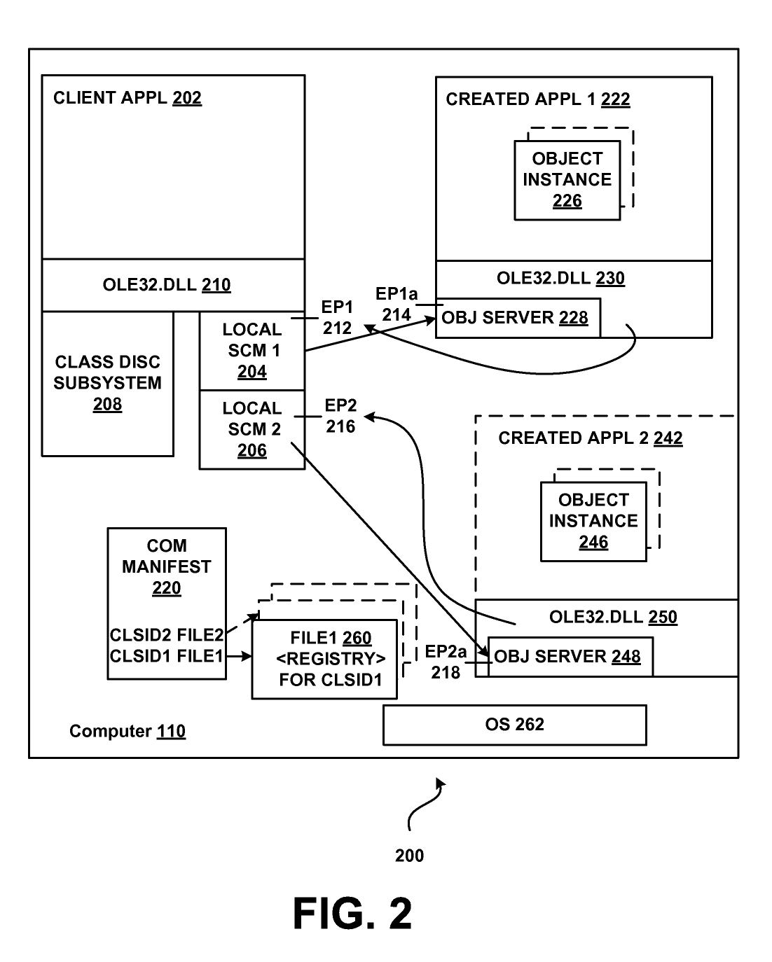

FIG. 2 illustrates one embodiment of a system 200 for providing access to software components to an isolated application as described above. It will be appreciated that other embodiments of the system using other componentized software models are contemplated. The components may be written in any combination of any known or future-developed programming language. The term “component” as used herein refers to a block of executable code which is accessible via or known by a unique name or identifier. System 200 may reside on a computer such as computer 110 described above with respect to FIG. 1. The operating system in some embodiments of the invention creates a local namespace of component metadata and associates the namespace with the application. In FIG. 2 for example, operating system 262 may create a local namespace (e.g., a COM manifest such as COM manifest 220 and its associated files file1 260, etc.) and associate this set of files with the application 202. Hence, in some embodiments of the invention, the COM manifest and its associated files comprise the local database (namespace) which is used to establish relationships between an application and a component or set of components used by the application, as described above. In FIG. 2, a COM-based client application 202 includes a library (e.g., OLE32.DLL 210, containing core OLE functions. OLE stands for Object Linking and Embedding. It enables the creation of objects by one application and the linking or embedding of the objects in a second application. These objects may represent the components requested by the main application.) A class discovery subsystem 208 of an operating system 262 may provide class information. One or more local modules capable of creating a new process (e.g., local SCM 1 204 and local SCM 2 206) may also be associated with the client application process 202. When client application 202 wants to create another process in-proc for the component (in the same process as the requesting application), as described above, the application may request an instance of the class by specifying a class identifier (CLSID) and other appropriate information such as an interface identifier, etc. During class discovery, the COM manifest 220 for that executable is retrieved, and the associated file1 260 is examined. File1 260 may represent a (potentially modified) subset of a global registry. COM Manifest 220 and file1 260, etc. may comprise a local file or set of files that replace the global registry, and which are used during lookup of a requested component instead of a global database (e.g., Registry), as described more fully below. The executable associated with the indicated class identifier is instantiated and is loaded into the client application process. When client application 202 wants to activate a component software unit out-of-proc (in a process separate from the requesting application), the client application process 202 may create a local SCM within its own process, using software available in its support library (e.g., OLE32.DLL). The requesting application can request a local SCM or other local process-creating module to create a new isolated process in which the created application, (e.g., created application 1, 222) may execute. The created application (e.g., a component) may receive its own copy of the library (e.g., OLE32.DLL 230). A communications endpoint to the requested component is provided to the creating application by the created local SCM in the requesting application (e.g., creating application 1 202 is provided with endpoint 1a 214.) A communications endpoint to the requesting application is provided to the created application by the created local SCM in the requesting application (e.g., created application 1 222 is provided with endpoint 1 212.) The object server 228 of the created application (e.g., created application 1 222) requests the creation of an instance of an object 226 and returns the endpoint of the object (EP1 212) to the local SCM 204. It will be appreciated that created application 1 222 may create multiple object instances. Client application 202 can create other isolated environments (for created application 2 242 for instance). A local SCM is created for each new out-of-proc process, such as created application 2 242. Created application 2 242 may have its own copy of the support library (e.g., COM library OLE32.dll 250), its own object server 248 and is capable of creating its own object instances (e.g., object instance 246, etc.). Appropriate endpoints (e.g., endpoints EP2 216 and EP2a 218 may be similarly established.

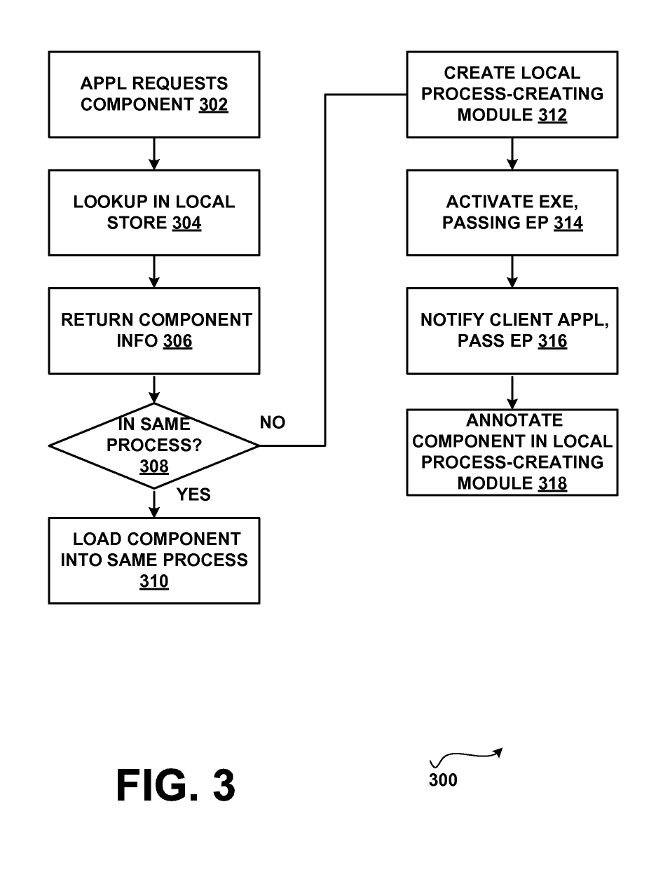

FIG. 3 illustrates a flow diagram of providing access to a component to an isolated application in accordance with some embodiments of the invention. In some embodiments of the invention, the system described in FIG. 2 performs the method described although it will be appreciated that other systems may also perform this method. At 302 an application such as application 202 described above requests a component. For example, client application 202 may request the creation of an object representing a component, an instance of a class. At 304, the requested component may be looked up in a local store (e.g., database or file). In some embodiments of the invention, the local store is created by the operating system described above from metadata associated with a component or set of components upon installation of the component(s) and/or application and this local store is used to determine the component or set of components to be associated with a requesting application. Alternatively, the local datastore may be provided by the application writer, modified by the system administrator or both. In some embodiments of the invention, the requested component may be requested by identifying the component using a unique identifier such as a class identifier such as a CLSID. For example, during the class discovery portion of providing COM access to an isolated application in accordance with some embodiments of the invention, the class discovery subsystem may look up the CLSID (e.g., CLSID1) in the appropriate COM manifest (e.g., COM manifest 220). If it is found, the corresponding information (e.g., information from File1 260) is returned at 306. If it is not found, of course, an error message will be generated. For example, in the case of a COM component, class information for the CLSID may be retrieved. Looking the CLSID up in the COM manifest may comprise the following: getting the address of the current stack position and determining if the executable at the address is associated with a COM manifest. If no COM manifest is associated with the executable, an error is returned. If the executable at the address indicated is associated with a COM manifest, the corresponding COM manifest is searched for the CSLID. If found processing continues. If the CSLID is not found, if the address is an address of an executable, an error message is sent to the application. If the address is not an address of an executable, the next sequential position in the stack is examined and processing continues.

At 308, if the component is to be activated within the same process as the requesting application, the component executable may be loaded into the requesting application's process at 310. If the component is to be activated in its own separate isolated process, the requesting application may create a local process-creating module or object (312). For example, the client application may create a local SCM as described above. At 314 the component may be activated in its own separate isolated process and a communications endpoint enabling communication between created and requesting process may be passed to the process-creating module or object. At 316 the requesting application is notified of the creation of the component (e.g. the out-of-proc COM component) receiving an endpoint to communicate with it. At 318 the component is annotated in the local process-creating module (e.g. in the local SCM) as described above.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A computer-implemented method comprising:
receiving a request from a creating application to create a new instance of a class using a class identifier, wherein the new instance comprises an executable of a COM software component;
examining a local file associated with the creating application, wherein the local file replaces a global namespace comprising a registry, the registry comprising information required to create the new instance; and
loading the new instance into one of a process in which a requesting application is running or a separate process in which the component will run.

2. The method of claim 1, further comprising:
determining whether the class identifier is located in the local file associated with the creating application;
if the class identifier is not located in the local file associated with the creating application, generating an error message; and
if the class identifier is located in the local file associated with the creating application, retrieving the information required to create the new instance.

3. The method of claim 1, further comprising:
getting an address of a current stack position;
determining whether an executable at the address is associated with a COM manifest; and
if the executable at the address is associated with the COM manifest, searching the associated COM manifest for the class identifier.

4. The method of claim 1, further comprising:
getting an address of a current stack position;
determining whether an executable at the address is associated with a COM manifest; and
if no COM manifest is associated with the executable at the address, returning an error message.

5. The method of claim 1, further comprising:
creating a local process-creating module; and
activating the executable of the COM software component and passing a communication endpoint to the executable to the local process-creating module, the communication endpoint being shared only with the local process-creating module.

6. The method of claim 1, wherein the creating application comprises a support library and an object server.

7. The method of claim 1, further comprising:
receiving a second request from the creating application to create a second new instance of the class using the class identifier, wherein the second new instance comprises an executable of a COM software component;
examining the local file associated with the creating application, wherein the local file replaces a global namespace comprising a registry, the registry comprising information required to create the second new instance; and
loading the second new instance into one of the process in which a requesting application is running or the separate process in which the component will run.

8. The method of claim 1, further comprising:
receiving a third request from the creating application to create a third new instance of a second class using a second class identifier, wherein the third new instance comprises an executable of a COM software component;
examining the local file associated with the creating application, wherein the local file replaces a global namespace comprising a registry, the registry comprising information required to create the third new instance; and
loading the third new instance into one of the process in which a requesting application is running or the separate process in which the component will run.

9. A computer-readable medium having program code stored thereon that, when executed by a computing environment, causes the computing environment to:
receive a request from a creating application to create a new instance of a class using a class identifier, wherein the new instance comprises an executable of a COM software component;
examine a local file associated with the creating application, wherein the local file replaces a global namespace comprising a registry, the registry comprising information required to create the new instance; and
load the new instance into one of a process in which a requesting application is running or a separate process in which the component will run.

10. The computer-readable medium of claim 9, having further program code stored thereon that, when executed by a computing environment, causes the computing environment to:
determine whether the class identifier is located in the local file associated with the creating application;
if the class identifier is not located in the local file associated with the creating application, generate an error message; and
if the class identifier is located in the local file associated with the creating application, retrieve the information required to create the new instance.

11. The computer-readable medium of claim 9, having further program code stored thereon that, when executed by a computing environment, causes the computing environment to:
get an address of a current stack position;
determine whether an executable at the address is associated with a COM manifest; and
if the executable at the address is associated with the COM manifest, search the associated COM manifest for the class identifier.

12. The computer-readable medium of claim 9, having further program code stored thereon that, when executed by a computing environment, causes the computing environment to:
get an address of a current stack position;
determine whether an executable at the address is associated with a COM manifest; and
if no COM manifest is associated with the executable at the address, return an error message.

13. The computer-readable medium of claim 9, having further program code stored thereon that, when executed by a computing environment, causes the computing environment to:
create a local process-creating module; and
activate the executable of the COM software component and passing a communication endpoint to the executable to the local process-creating module, the communication endpoint being shared only with the local process-creating module.

14. The computer-readable medium of claim 9, wherein the creating application comprises a support library and an object server.

15. The computer-readable medium of claim 9, having further program code stored thereon that, when executed by a computing environment, causes the computing environment to:
receive a second request from the creating application to create a second new instance of the class using the class identifier, wherein the second new instance comprises an executable of a COM software component;
examine the local file associated with the creating application, wherein the local file replaces a global namespace comprising a registry, the registry comprising information required to create the second new instance; and
load the second new instance into one of the process in which a requesting application is running or the separate process in which the component will run.

16. The computer-readable medium of claim 9, having further program code stored thereon that, when executed by a computing environment, causes the computing environment to:
receive a third request from the creating application to create a third new instance of a second class using a second class identifier, wherein the third new instance comprises an executable of a COM software component;
examine the local file associated with the creating application, wherein the local file replaces a global namespace comprising a registry, the registry comprising information required to create the third new instance; and
load the third new instance into one of the process in which a requesting application is running or the separate process in which the component will run.

17. A system comprising:
a processor;
memory having program code stored thereon that, when executed by a computing environment, causes the computing environment to:
receive a request from a creating application to create a new instance of a class using a class identifier, wherein the new instance comprises an executable of a COM software component;
examine a local file associated with the creating application, wherein the local file replaces a global namespace comprising a registry, the registry comprising information required to create the new instance; and
load the new instance into one of a process in which a requesting application is running or a separate process in which the component will run.

18. The system of claim 17, wherein the memory has further program code stored thereon that, when executed by a computing environment, causes the computing environment to:
determine whether the class identifier is located in the local file associated with the creating application;
if the class identifier is not located in the local file associated with the creating application, generate an error message; and
if the class identifier is located in the local file associated with the creating application, retrieve the information required to create the new instance.

19. The system of claim 17, wherein the memory has further program code stored thereon that, when executed by a computing environment, causes the computing environment to:
get an address of a current stack position;
determine whether an executable at the address is associated with a COM manifest; and
if the executable at the address is associated with the COM manifest, search the associated COM manifest for the class identifier.

20. The system of claim 17, wherein the memory has further program code stored thereon that, when executed by a computing environment, causes the computing environment to:
get an address of a current stack position;
determine whether an executable at the address is associated with a COM manifest; and
if no COM manifest is associated with the executable at the address, return an error message.
